(19) United States
(12) Patent Application Publication
(10) Pub. No.: US 2013/0299308 A1
(43) Pub. Date: Nov. 14, 2013

(54) LETTER PROCESSING APPARATUS AND LETTER PROCESSING METHOD

(71) Applicant: KABUSHIKI KAISHA TOSHIBA, Tokyo (JP)

(72) Inventor: Takayuki MIMURA, Kanagawa (JP)

(73) Assignee: Kabushiki Kaisha Toshiba, Tokyo (JP)

(21) Appl. No.: 13/868,608

(22) Filed: Apr. 23, 2013

(30) Foreign Application Priority Data
May 11, 2012 (JP) 2012-109272

(51) Int. Cl. B65G 43/08

(52) U.S. Cl. CPC B65G 43/08
USPC 198/358

(57) ABSTRACT

A letter processing apparatus has a first transporting passage, a first detection unit, a second transporting passage, a second detection unit, a third transporting passage, and a sorting control unit. The first detection unit detects the letter transported in the first transporting passage. The second detection unit detects the letter transported in the second transporting passage. The third transporting passage causes the letter to pass. The sorting control unit directs a first letter to the first transporting passage and directs a second letter transported after the first letter to the second transporting passage. On the basis of the inter-letter distance between the two letters being transported, the transporting speed of each letter, and the preparation time from end time for the first detection to the start time of the second detection, a third letter is sorted to the first transporting passages, the second transporting passages or the third transporting passage.

### CROSS-REFERENCE TO RELATED APPLICATION

This application is based upon and claims the benefit of priority from Japanese Patent Application No. 2012-109272, filed May 11, 2012, the entire contents of which are incorporated herein by reference.

### FIELD

Embodiments described herein relate to a letter processing apparatus and a letter processing method.

### BACKGROUND

In recent years, with progress in the automation for processing of post and other letters, various technologies for letter processing have been disclosed. For example, a technology has been developed for a classification apparatus as follows: a letter image is read, the address information is recognized from the read image, and the letter is classified based on the recognition of the address information.

The classification apparatus has a detector that detects the weight of the letter, and classifies the letter according to the detected result of the weight.

It is necessary for the classification apparatus to process the letters at an extremely high rate and as a result, the detecting process for a letter may not accurately match the detected information with the letter corresponding to the information. For example, on occasion a detector corresponding to the letter transporting passage, may receive a second letter for reading after the detection of the first letter, but in a way that overlaps the first letter in time. Thus a correct detection of the second letter is impossible if the second letter arrives at the detector before the detector is ready for analyze the second letter.

### DESCRIPTION OF THE DRAWINGS

FIG. 1 is a schematic diagram illustrating an example of a postal classification processor where a letter processing apparatus can be used, according to one embodiment.

FIG. 2 is a diagram illustrating an example of the configuration of a portion of the transporting section, according to one embodiment.

FIG. 3 is a diagram illustrating the inter-letter distance, the transporting speed, and the receivable time, according to one embodiment.

FIG. 4A is a diagram illustrating an example of control of transporting of the letters, according to one embodiment.

FIG. 4B is a flow chart illustrating an example of control of transporting of the letters, according to one embodiment.

FIG. 5 is a diagram illustrating the configuration of a portion of the control mechanism of the post classification processor, according to one embodiment.

### DETAILED DESCRIPTION

In general, according to one embodiment, the present disclosure will be explained with reference to the drawings.

The letter processing apparatus in an embodiment of the present disclosure has a first transporting passage, a first detection unit, a second transporting passage, a second detection unit, a third transporting passage, and a sorting control unit. The first detection unit detects the letter transported in the first transporting passage. The second detection unit detects the letter transported in the second transporting passage. The third transporting passage is a bypass passage by which a letter may go around or by-pass the first and second passages. The sorting control unit is configured to direct or guide the first letter to the first transporting passage and direct or guide the second (next) letter transported after the first letter to the second transporting passage. Here, on the basis of the distance or gap, in space or time, between the two letters being transported, the transporting speed of each letter, and the preparation time from end of the first detection to the time when detection of the second detection can be carried out at the first and second detection unit, the third letter transported after the second letter is directed to one of the first, second or third (bypass) transporting passages.

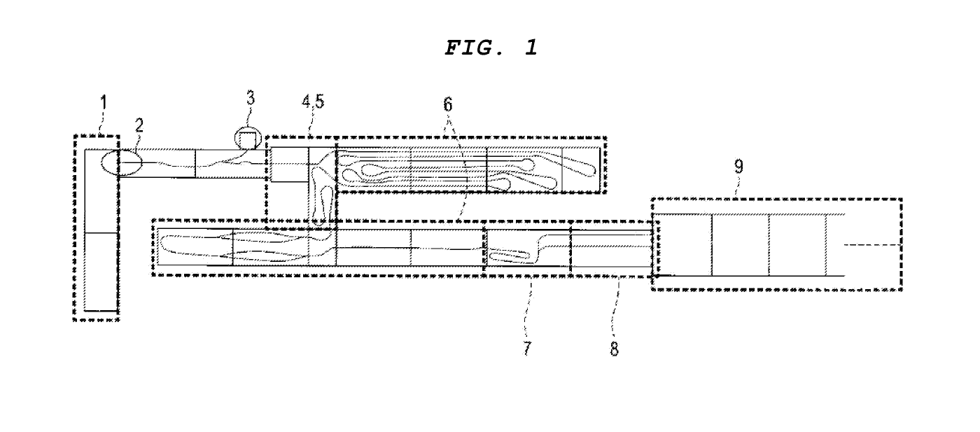

FIG. 1 is a schematic diagram illustrating the configuration of the postal classification processor where the letter processing apparatus can be used, according to one embodiment.

As shown in FIG. 1, the post classification processor includes a feeding section 1, a fetching section 2, an excluding/collecting section 3, a barcode read section 4, an OCR scanner section 5, a transporting section 6, a stage pass section 7, a classification section 8, and a collecting section 9.

The feeding section 1 stores the letters (posts) to be classified. The fetching section 2 fetches the letters from the feeding section 1, and sends the fetched letters into the excluding/collecting section 3. The excluding/collecting section 3 culls from the stream of letters the foreign object-mixed letters and the letters out of the prescribed size range, etc. and stores them to a side of the apparatus, and sends the remaining letters appropriate for classification to the barcode read section 4 and the OCR scanner section 5.

The barcode read section 4 scans each letter to read the barcode appearing on a letter, passing therethrough, if a barcode corresponding to the P.O. Box number or address information is provided on the letters. The OCR scanner section 5 reads an image of the writing or printing on the letter, and is configured to recognize addressee information for example, P.O. Box number and/or address information from the image.

The transporting section 6 transports the letter on the basis of the result of the reading of the barcode or the result of recognition of the addressee information. The stage pass section 7 drives the stage pass gate to sort the letters to the various stages on the basis of the result of recognition of the addressee information. The sorted letters are then transported to the classification section 8, which directs the letters to the various collecting pockets of the collecting section 9 on the basis of the result of read of the barcode or the result of recognition of the addressee information.

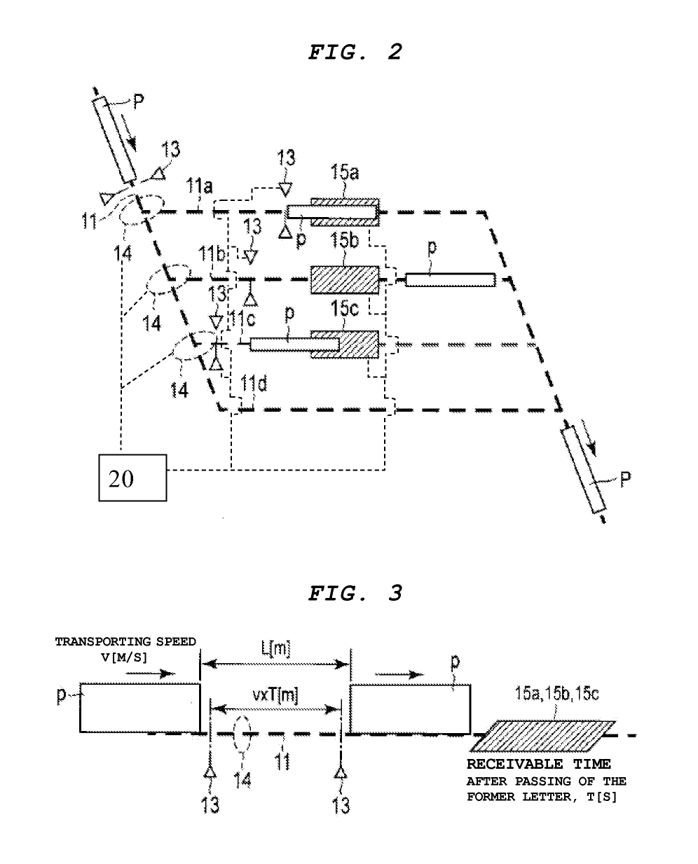

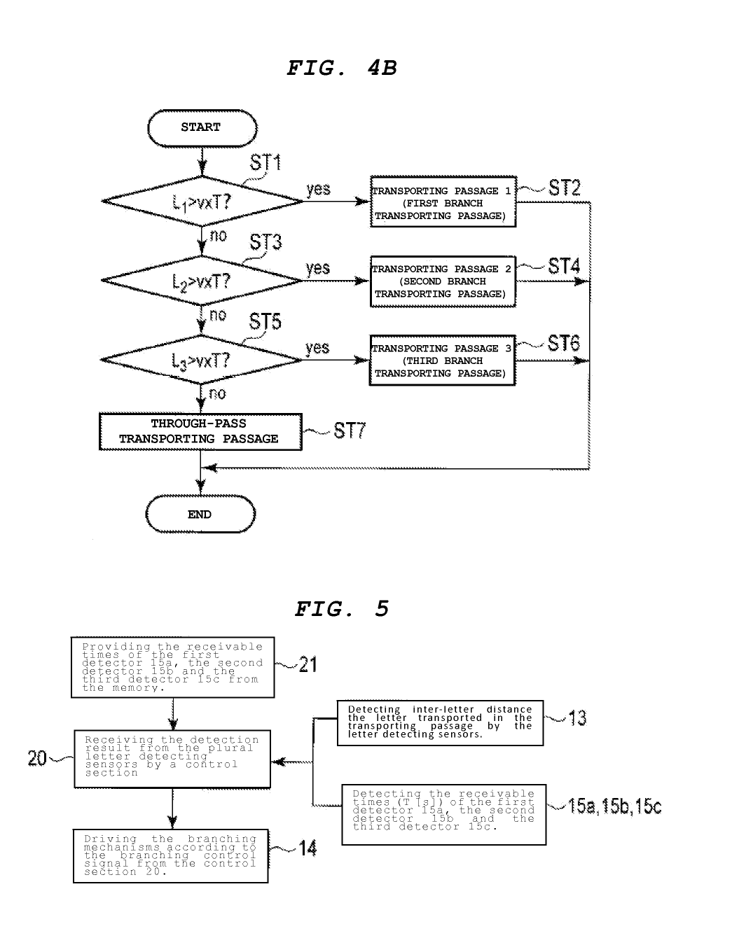

FIG. 2 is a diagram illustrating an example of the configuration of a portion of the transporting section 6. FIG. 5 is a diagram illustrating the configuration of a portion of the control mechanism in the post classification processor.

As shown in FIG. 2, the transporting section 6 includes a multi-branch transporting passage 11. The transporting passage 11 includes a first branch transporting passage 11a, a second branch transporting passage 11b, a third branch transporting passage 11c, and a bypass transporting passage 11d. Here, the transporting section 6 has plural letter detecting sensors 13 (such as transmissive or light beam based sensors) arranged along the transporting passage 11, and a plurality of branching mechanisms located downstream of the detector of 11, in the letter transport path. Branch passages 11a, 11b and 11c also include a sensor 13a, b, or c, therealong. In addition, the transporting section 6 has a first detector 15a arranged corresponding to the first branch transporting passage 11a, a second detector 15b arranged corresponding to the second branch transporting passage 11b, and a third detector 15c arranged corresponding to the third branch transporting passage 11c. For example, the first detector 15a, the second detector 15b, and the third detector 15c are detectors for detecting the weight of letter P. The detectors 15a-c are located in the branches at a position downstream of the sensors 13a-c on each branch.

The letter transported in the transporting passage 11 is detected by the letter detecting sensor 13, and the detection result is sent to a control section 20. The position of the branching mechanisms 14 i.e., whether to direct a letter to a branch or further downstream therefrom, are selected according to the branching control signal from the control section 20 to branch the letters.

In the following, with reference to FIG. 3, the inter-letter distance, the transporting speed, and the receivable time will be explained.

The control section 20 (FIG. 2) receives the detection result from the letter detecting sensors 13 arranged on the transporting passage 11, and the inter-letter distance (L [m]) between the two letters being transported is detected on the basis of the detection result from the plural letter detecting sensors 13, 13a-c,. For example, the control section 20 can detect the inter-letter distance between the first letter and the second letter transported after the first letter, and it also can detect the inter-letter distance between the first letter and any third letter after the first letter. That is, the control section 20 can detect the inter-letter distance between two letters transported consecutively, and it also can detect the inter-letter distance between two non-consecutively transported letters.

On the basis of the detection results from the letter detecting sensors 13, 13a-c, the control section 20 can also determine the letter transporting speed (v [m/s]). Here, the transporting speeds of the letters are substantially the same.

Also, the control section 20 can detect the received times (T [s]) of the letters at the first detector 15a, the second detector 15b and the third detector 15c. Another scheme provides a memory 21 that stores the received times of the letters at the first detector 15a, the second detector 15b and the third detector 15c, which is then read by the control section 20. The receivable time of the detectors 15a-c is the time measured from the end of detection of a letter by the first detector 15a-c to the time when it is possible to detect the next sent-in letter. In other words, the receivable time is the time lag between passing of the former letter to the start of the detection for the next letter at a detector 15a-c.

In the following, the control of transporting of the letters will be explained. According to the present embodiment, it is possible to carry out detection processing for the three transporting passages, that is, the first branch transporting passage 11a, the second branch transporting passage 11b and the third branch transporting passage 11c (allowing process of weight detection). In the following explanation, it is assumed that no detection process occurs in one of the transporting passages, that is, the pass-through or bypass transporting passage 11d. However, the control of transporting of the letters according to the present embodiment can also be carried out for the case when there are two or more transporting passages that can carryout the detection process and there are one or more bypass passages.

For example, the control section 20 directs a first letter to be sorted to the first branch transporting passage 11a, and a second letter to be sorted to the second branch transporting passage 11b. Then, the control section 20 directs a third letter to be transported to the third branch transporting passage 11c after sending the second letter to be sorted to the second passage.

Then, based on of the inter-letter distance between the letters being transported, the control section 20 detects the transporting speeds of the letters, and the receivable times of the first detector 15a, the second detector 15b and the third detector 15c, then sends a next fourth letter, after the third letter is sent to one of the first branch transporting passage 11a, the second branch transporting passage 11b, the third branch transporting passage 11c or the through pass transporting passage 11d.

For example, when the first inter-letter distance, i.e., the distance or space between the third letter and the fourth letter is longer than the movement distance of the letter corresponding to the receivable time (that is, the first inter-letter distance (L[m])>letter transporting speed (v) times (x) receivable time (T[m])), the control section 20 sends the fourth letter to one of the first branch transporting passage 11a, the second branch transporting passage 11b, or the third branch transporting passage 11c. For example, based on L[m}>v·T[m], the control section 20 directs the fourth letter to be sorted to the first branch transporting passage 11a because the inter letter distance is longer than the movement distance, or better stated, based on the speed of the letter passage through the passages, and the position of a letter in the passages 11a-c, the controller selects an appropriate passage among passages 11a-c such that the next letter will arrive at a detector, 15a-c, after the previous letter therein has passed through the respective detector 15a-c.

For example, when the first inter-letter distance is greater than the movement distance corresponding to the preparation time, and the second inter-letter distance between the first letter and the fourth letter is longer than the movement distance corresponding to the preparation time, the control section 20 directs the fourth letter to be sorted to the first branch transporting passage 11a.

For example, when the second inter-letter distance is shorter than the movement distance corresponding to the preparation time, the control section 20 directs the fourth letter to be sorted to the through pass transporting passage 11d.

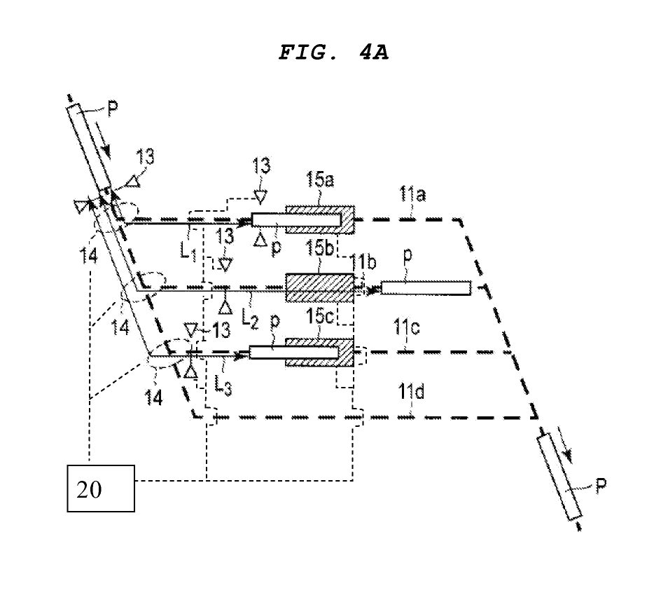

FIG. 4A is a diagram illustrating an example for the control of transporting the letters. FIG. 4B is a flow chart illustrating an example for the control of transporting the letters.

In one embodiment, the control section 20 directs the first letter to the first branch transporting passage 11a, directs the next, second letter to the second branch transporting passage 11b after the first letter is transported, and directs the third letter to the third branch transporting passage 11c after the second letter is transported.

In addition, on the basis of the inter-letter distance L₁, i.e., physical spacing, between the first letter and the fourth letter transported after the third letter, the inter-letter distance L₂ between the second letter and the fourth letter, the inter-letter distance L₃ between the third letter and the fourth letter, the transporting speeds (v) of the various letters, as well as the receivable times (T) of the first detector 15a, the second detector 15b and the third detector 15c, the control section 20 directs the fourth letter to be sorted to one of the first branch transporting passage 11a, the second branch transporting passage 11b, the third branch transporting passage 11c or the through pass transporting passage 11d based on an analysis that the detector of a branch will be clear to receive the letter by the time it arrives at the detector.

For example, when the condition of L1>v×T is met (YES in ST1), the control section 20 selects the first branch transporting passage 11a (ST2), and it controls the branching mechanisms 14 so that the fourth letter is transported to the first branch transporting passage 11a.

Also, when the condition of L1>v×T is not met (NO in ST1) but the condition of L2>v×T is met (YES in ST3), the control section 20 selects the second branch transporting passage 11b (ST4), and controls the branching mechanisms 14 so that the fourth letter is transported to the second branch transporting passage 11b.

When the condition of L1>v×T, and L2>v×T are not met (NO in ST3) but the condition of L3>v×T is met (YES in ST5), the control section 20 selects the third branch transporting passage 11c (ST6), and it controls the branching mechanisms 14 so that the fourth letter is transported to the third branch transporting passage 11c.

When the condition of L1>v×T, and L2>v×T and L3>v×T are not met (NO in ST5), the control section 20 selects the pass through or bypass transporting passage 11d (ST7), and it controls the branching mechanisms 14 so that the fourth letter is transported to the pass through transporting passage 11d.

In this way, because the letter processing apparatus of the present embodiment, has two or more transporting passages that is enabled for detection processing at least one transporting passage that does not include detection processing, the apparatus can detect address information for a plurality of letters being transported at high speed with a high efficiency (for example, detection of weight) by using the two or more transporting passages configured to provide the detection process. For the letter processing apparatus of the present embodiment, it is possible to make an appropriate selection of the transporting passage, through the detection process to decrease miss-detection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A letter processing apparatus comprising:
a first transporting passage,
a first detection unit configured to detect a presence of the letter in the first transporting passage,
a second transporting passage,
a second detection unit configured to detect the presence of the letter in the second transporting passage,
a third transporting passage, and
a sorting control unit configured to direct the letter to one of the first transporting passage, the second transporting passage, or the third transporting passage, in response to a first inter-letter distance between a first letter and a second letter, a transporting speed of the first letter and the second letter, and a preparation time.

2. The letter processing apparatus according to claim 1, wherein a second inter-letter distance corresponds to a distance between the first letter and a third letter; and a movement distance corresponds to a product of the preparation time and the transporting speed.

3. The letter processing apparatus according to claim 2, wherein the preparation time is determined from an end time of a detection for the first letter to a start time of detection for the second letter.

4. The letter processing apparatus according to claim 3, wherein the sorting control unit is configured to direct the third letter to the first transporting passage or the second transporting passage in response to the first inter-letter distance being longer than the movement distance.

5. The letter processing apparatus according to claim 3, wherein the sorting control unit is configured to direct the third letter to the first transporting passage in response to the first inter-letter distance being shorter than the movement distance and the second inter-letter distance is longer than the movement distance.

6. The letter processing apparatus according to claim 3, wherein the sorting control unit is configured to direct the third letter to the third transporting passage when the second inter-letter distance is shorter than the movement distance.

7. The letter processing apparatus according to claim 1, wherein the first detection unit and the second detection unit detect a weight of the letter.

8. The letter processing apparatus according to claim 1 wherein the third transporting passage is a bypass passage.

9. A letter processing method comprising:
moving a first letter to a first transporting passage,
detecting the first letter transported in the first transporting passage by a first detection unit;
moving a second letter transported after the first letter to a second transporting passage,
detecting the second letter transported in the second transporting passage by a second detection unit;
moving a third letter, transported after the second letter, to one of the first transporting passage, the second transporting passage, or a third transporting passage wherein the sorting is responsive to an inter-letter distance between the letter, a transporting speed of the letter, and a preparation time.

10. The letter processing method of claim 9, further comprising:
determining the preparation time from an end time of a detection for the first letter to a start time of detection for the second letter.

11. The letter processing method of claim 9, wherein a first inter-letter distance corresponds to a first distance between the second letter and the third letter, a second inter-letter distance corresponds to a second distance between the first letter and the third letter; and a movement distance corresponds to a product of the preparation time and the transporting speed.

12. The letter processing method of claim 11, further comprising:
moving the third letter to the first transporting passage or the second transporting passage in response to the first inter-letter distance being longer than the movement distance.

13. The letter processing method of claim 11, further comprising:
moving the third letter to the first transporting passage in response to the first inter-letter distance being shorter than the movement distance and the second inter-letter distance is longer than the movement distance.

14. The letter processing method of claim 11, further comprising:
moving the third letter to the third transporting passage when the second inter-letter distance is shorter than the movement distance.

15. The letter processing method of claim 11, further comprising:
detecting a weight of the first letter with the first detection unit; and
detecting a second weight of the second letter with the second detection unit.

16. A letter processing device comprising:
a first transporting passage,
a first detection unit configured to detect a presence of the letter in the first transporting passage,
a second transporting passage,
a second detection unit configured to detect the presence of the letter in the second transporting passage,
a third transporting passage, and
a sorting control unit configured to direct the letter between the first transporting passage, the second transporting passage, or the third transporting passage, in response to a first inter-letter distance between a first letter and a second letter, a second inter-letter distance corresponds to a second distance between a first letter and a third letter, a transporting speed of a first letter and a second letter, a preparation time wherein the preparation time is determined from an end time of a detection for a first letter to a start time of detection for a second letter, and a movement distance corresponds to a product of the preparation time and the transporting speed.

17. The letter processing device according to claim 16, wherein the sorting control unit is configured to direct the third letter to the first transporting passage or the second transporting passage in response to the first inter-letter distance being longer than the movement distance, to direct the third letter to the first transporting passage in response to the first inter-letter distance being shorter than the movement distance and the second inter-letter distance is longer than the movement distance, or to direct the third letter to the third transporting passage when the second inter-letter distance is shorter than the movement distance.

18. The letter processing device according to claim 16, wherein the first detection unit and the second detection unit detect a weight of the letter.

19. The letter processing device according to claim 16 wherein the third transporting passage is a bypass passage.

20. The letter processing device according to claim 16, further comprising:
a fourth transportation passage wherein the fourth transportation passage is a bypass passage.
